(19) United States
(12) Patent Application Publication
(10) Pub. No.: US 2009/0305038 A1
(43) Pub. Date: Dec. 10, 2009

(54) METHOD FOR FUNCTIONALISING A POLYMER FIBRE SURFACE AREA

(75) Inventors: Maxime Duran, Cavanac (FR); Richard Morlat, Livry-Gargan (FR); Eric Dallies, La Ravoire (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Saint-Gobain Materiaux De Construction S.A.S, Courbevoie (FR)

(21) Appl. No.: 12/092,210

(22) PCT Filed: Nov. 8, 2006
(86) PCT No.: PCT/FR06/51150

§ 371 Date: Aug. 27, 2008

(30) Foreign Application Priority Data
Nov. 10, 2005 (FR) 0553433

(51) Int. Cl. B05C 21/00; B05D 1/18; B05D 1/02; B05D 1/28; B05D 3/12; B05D 3/04; B29C 59/16; D02G 3/36

(52) U.S. Cl. 428/395; 427/434.2; 427/421.1; 427/428.2; 427/289; 427/444; 264/448; 118/68; 428/394

(57) ABSTRACT

A method of surface functionalization of an organic fiber, characterized in that a surface portion of the fibers is chemically modified using a uniform surface treatment at atmospheric pressure, in a controlled gas environment, and in that said surface portion is brought into contact with a solution comprising at least one sizing agent making it possible to improve the functionalities of said fiber.

The present invention relates to a method of functionalizing a surface portion of a reinforcement fiber made of plastic, especially polymer-based, for example chosen from polyolefins, polyamides, polyesters, polyacrylonitrile and polyvinyl alcohols and copolymers thereof.

According to another aspect of the invention, its subject matter is also the use of such a surface-functionalized fiber as a reinforcement component, especially for example in a cement-based matrix.

Innumerable publications concerning the use of various natural or synthetic, organic and inorganic fibers are known. Fibers made of cellulose, polyamide, polyester, polyacrylonitrile, polypropylene, polyvinyl alcohol and polyaramid, amongst others, have already been the subject of investigation for cement reinforcement. Similarly, studies on glass, steel and carbon fibers are known. Amongst all these fibers, none has hitherto all the required properties, especially for cement.

For example, glass has a poor chemical stability, steel undergoes corrosion and has too high a density, carbon is too brittle, adheres badly and is costly, cellulose has insufficient durability for certain applications (especially for roofing), and ordinary polyethylene and polypropylene have insufficient tensile strength.

Furthermore, fibers based on polyacrylonitrile (PAN) and on polyvinyl alcohol (PVA) may be used and make it possible to obtain a product made of fiber-cement having a high tensile strength in combination with an acceptable ductility. Unfortunately PAN and PVA fibers are expensive and considerably increase the cost price of the fiber-cement products containing them.

A method is known from documents U.S. Pat. No. 4,310,478 and U.S. Pat. No. 5,330,827 for manufacturing hydrophilic PP fibers from thin films that comprises an operation for unidirectional mechanical orientation of the PP film, followed by implementation of a corona treatment on the oriented film, or/and deposition of a wetting agent, then finally a step of producing hydrophilic chopped fibers by fibrillation cutting.

Furthermore, document WO 97/32825 describes a plasma process at reduced pressure (0.1 to 10 torr) for increasing the adhesion between the surface of the PP fibers and cementitious matrices without the use of a size after the plasma treatment.

Documents WO 03/095721 and WO 04/033770 have as their subject matter a method for manufacturing PP fibers that improve the mechanical properties (especially crack resistance) of fiber-cement products. The PP fibers consist of a core and a shell that is grafted by an acrylic derivative or that comprises a thermoplastic elastomer portion. This shell may also by the subject of a corona treatment and of a coating of polymers modified by grafting polar functional groups (aqueous dispersion).

Surface treatments of reinforcement fibers using a “corona” type electrical discharge are known, especially from Patent Application EP 1 044 939 A1.

It will be recalled that a surface treatment using an electrical discharge is characterized by physico-chemical modifications to the surface of the material that result from the action of the species known as active species, generated by the electrical discharge.

From a general point of view, an electrical discharge is initiated (breakdown of the gas) between two electrodes when they are subjected to a potential difference, in a controlled atmosphere of a gas mixture comprising at least helium or argon or nitrogen. Following the application of an electric field, the gas ionizes (avalanche principle). The electrons and ions created acquire speed and interact with the neutral particles of the gas. Depending on their kinetic energy, this results in the creation of new charged particles and excited chemical species. In local thermodynamic equilibrium, the excited molecules have a tendency to return to their ground state by emitting a photon whose energy corresponds to the energy difference between the excited and ground levels. When the deexcitation is instantaneous, the transitions and emitting levels are said to be radiative. Their lifetime is of the order of 10⁻⁸ s. However, according to the rules of quantum transitions, certain species have very low deexcitation probabilities. They are metastable atoms or molecules. Their lifetime is between 10⁻³ and 10⁻⁵ seconds. They therefore have a high probability of collisions with the neutrals of the gas, which may lead to the loss of their energy. These excitation transfers occur even more effectively the higher the pressure. The interactions in the gas also lead to the dissociation of molecules, resulting in a deficit of chemical bonds. These fragments or radicals tend to make up for this deficit and are therefore chemically very reactive. Finally, the neutrals also store energy, in the form of kinetic or vibrational energy.

To summarize, the energetic species known as active species derived from an ionized gas are:

electrons;

positive and negative ions;

metastable atoms and molecules;

species having kinetic or vibrational energy;

free radicals; and

photons.

All these species are capable of interacting with one another and with the surface of the materials. Their potential is therefore variable, depending on the type of electrical discharge and the experimental conditions, which will determine their number, their distribution and their energy.

In the case of surface treatment, the energy distribution of the electrons is centered on a few electron volts. The abovementioned species are intended to come into contact with a substrate surface to be treated. The influence of each species generates modifications, to a greater or lesser depth, in the material depending on its energy and its mean free path in the solid. Apart from the photons, the active species of the plasma do not penetrate beyond about 10 nm into the material. In general, all the species derived from the electrical discharge will excite and, if they have enough energy, ionize the atoms of the substrate. If the energy transmitted is greater than the energy of the covalent bond between the polymer atoms, this results in the breaking of the chemical bonds, which produces radicals of variable size depending on the type of bond, namely a side bond (D(C−H)=4.3 eV) or a bond belonging to the chain itself (D(C−O)=3.6 eV).

More precisely, the ions may fragment chains and eject atoms or molecules. This mechanism increases with the energy and mass of the ion.

The gas metastables, which can lose their energy only by collisions, have enough energy to also break a polymer bond and lead to the creation of radicals. On the other hand, the atoms and molecules that have only kinetic and vibrational energy will transmit it in the form of heat. The radicals themselves will cause chemical grafting reactions accompanied by heat exchange. It must be borne in mind that all these species bombard the surface simultaneously and that a synergistic effect therefore exists. It is not really possible to attribute a given effect to one species. In addition, as in the gas, the excited and ionized radicals that are created and also the secondary electrons will interact with the neutrals and with one another, and photons are also emitted by deexcitation. All these energy transfers activate the surface and induce structural changes that may be expressed by a crosslinking, a degradation or a functionalization (grafting of new chemical functional groups) of the substrate, in this case a polymer fiber.

However, when the plasma gas(es) are at atmospheric pressure, various electrical discharge states exist. Thus it will be recalled that a surface treatment carried out using a “corona” type electrical discharge is characterized by an electrical discharge state of filamentary type at atmospheric pressure in air. The results of corona treatment on the surface portion of the substrate are generally unsustainable over time.

In fact, in the majority of industrial gases (argon, air, nitrogen, etc.), their breakdown at atmospheric pressure (which is in fact a transition toward a conducting state of the gas) is initiated by a large number of independent filaments or microdischarges, the characteristics of which are, in particular, a lifetime of less than 10⁻⁹ s, a mean radius of less than 100 μm and a current density between 100 and 1000 A/cm². These discharges may be demonstrated by a voltage/current oscillogram measured using a suitable experimental device, of which an illustration is given in FIG. 6.

These microdischarges are randomly ignited and extinguished over the entire surface of the electrodes, of which one at least may be covered by a dielectric barrier. In this filamentary state, when the materials to be treated are brought directly into contact with the electrical discharge, that is to say between the two electrodes, the surface treatment of the materials is carried out more or less uniformly. On the other hand, locally it may be imagined that the transformations induced by this type of treatment (filamentary discharge) will be highly inhomogeneous. Thus, a surface portion of the material that will have been exposed to a microdischarge will be much more degraded than another portion that will not have been exposed to one, in particular in the case of organic materials. The corona type electrical discharge, due to its intensity, has a tendency to create, in the areas where the microfilaments impact with the fiber surface, embrittlement areas (local heating, preferential crack initiation) that reduce their mechanical properties. This phenomenon is even more important when it is a question of a small diameter reinforcement fiber, made from an olefin-based material such as, for example, polypropylene. Furthermore, the inhomogeneity of the surface treatment may result in an inhomogeneity in terms of chemical reactivity with regard to a chemical agent having to be grafted thereto.

The filamentary electrical discharges (e.g. corona treatment), although making it possible to treat the surface of a polymer fiber so as to improve its incorporation into a cementitious matrix, display, however, disadvantages to which the present invention provides a solution.

Thus, the use of corona treatment (filamentary discharge in air at atmospheric pressure) has the following disadvantages:

this treatment is often limited to treatment of a 2D structure, the plane-plane configuration of the electrodes is well suited to a 2D geometry, the plastic films pass into the discharge and may be treated on the faces;

filamentary treatment is not uniform and is difficult to control knowing that its effectiveness strongly depends on the relative humidity in the air, for example;

filamentary treatment may degrade the treated surface, by local heating or fracture initiation, leading to a loss of mechanical properties of the fibers;

filamentary treatment deposits a significant quantity of electrical charges on the surface;

the chemistry of the treatment is limited to oxidation of the polymer surfaces; and

filamentary treatment makes it impossible for a thin organic, organo-mineral or mineral layer easily, in a controlled manner, to be deposited on the surface of the polymer (dusting problem, for example).

In addition, the inventors have been able to determine that when chopped fibers, treated by corona-type filamentary electrical discharge, are used directly in cementitious matrices, without carrying out post-sizing, a significant electrostatic charge accumulation occur at the surface of the polymers (since the substrate is directly in contact with the discharge where it is subjected to bombardment of the charged species (e⁻, ions, metastables), and that often poses problems in the handling and in the production of a good dispersion of the chopped fibers. In addition, the aging of plasma-treated fibers (without post-sizing) is poorly controlled.

The inventors have discovered, quite surprisingly and unexpectedly, that it is possible to modify the physico-chemical properties without degrading the mechanical properties (tenacity, modulus, etc.) of fibers made up of strands composed of X polymer-based fibers (for example, X is several hundred to several thousand) of diameter Y μm (for example, between 5 and 30 μm, and preferentially between 8 and 15 μm) due to uniform surface functionalization of the latter, in order to give these reinforcement fibers characteristics that they did not possess originally.

To that end, the method of continuous surface functionalization of an organic fiber is characterized in that a surface portion of the fibers is chemically modified using a uniform surface treatment at atmospheric pressure, in a controlled gas environment, and in that said surface portion is brought into contact with a solution comprising at least one sizing agent making it possible to improve the functionalities of said fiber.

Due to this continuous treatment method, it is possible to obtain functionalized fibers whose mechanical properties have not been impaired by the surface functionalization treatment.

In preferred embodiments of the invention, one or more of the following provisions may, moreover, be employed:

the functionalization of the surface portion of said fiber is carried out on a fiber deriving from the drawing of streams of molten material and from a drawing operation at a temperature below the melting point;

the functionalization of the surface portion of said fiber is carried out on a surface portion of a fiber resulting from the fibrillation of a drawn film;

the functionalization of the surface portion is carried out on a film drawn along a chosen direction until tearing of the film into fibrillated fibers occurs;

the functionalization of the surface portion is carried out on a woven, a veil, a nonwoven, a mesh or the like;

the fiber portion is brought into contact with the sizing agent by means of an operation in which said fiber portion is dipped into a solution comprising said sizing agent;

the fiber portion is brought into contact with the agent by spraying a solution comprising said sizing agent onto said fiber portion;

the fiber portion is brought into contact with the sizing agent by means of a transfer operation using a transfer device component, especially a size roll immersed in a solution comprising said sizing agent, or a stationary guide conveying the sizing agent onto the line of contact with the fibers;

said fiber portion is cut into a plurality of lengths;

the surface treatment is carried out in a controlled atmosphere comprising at least one ionized gas chosen from helium, argon or nitrogen, on its own or as a mixture;

the surface treatment is carried out by means of a uniform electrical discharge that is produced between two electrodes subjected to an AC supply having a frequency of a few kHz to a few MHz; and

the surface treatment is carried out by blowing the active species from the filamentary or uniform electrical discharge toward the substrate, the transport of the active species may for example take place in a tunnel through which at least said fiber travels.

According to another aspect of the invention, its subject matter is a fiber of which at least one surface portion is rendered chemically active by the functionalization method described previously, this fiber is characterized in that it comprises polymer chains.

In preferred embodiments of the invention, one or more of the following provisions may, moreover, be employed:

the reinforcement fiber is an organic fiber;

the reinforcement fiber consists of polymers, chosen from polyolefins, polyamides, polyesters, polyacrylonitrile and polyvinyl alcohols and copolymers thereof;

the reinforcement fiber is based on polypropylene;

the sizing agent comprises polyvinyl alcohol in aqueous solution; and

the agent comprises, in aqueous solution, a size comprising at least one product based on polyethylene glycol fatty acid ester and phosphoric acid ester compounds based on natural oil such as the one with the trademark “SYNTHESIN 7292” from Dr. Boehme, or at least one product based on a lubricating and antistatic mixture such as the one with the trademark “KB 144/2” from Cognis, or at least one product based on a fatty acid-derived polyethylene glycol ester such as the one with the trademark “STANTEX S6077” from Cognis, or at least one product based on nonionic surfactants and esterquats such as the one with the trademark “STANTEX S6087/4” from Cognis.

According to a further aspect of the invention, its subject matter is a “fiber-cement” product made from a hydraulic-setting composition comprising water, hydraulic binders and reinforcement fibers such as described previously.

According to a further aspect of the invention, its subject matter is an installation making it possible to implement the surface treatment method that is the subject of the invention, which is characterized in that it comprises at least one treatment zone, said zone being either (i) a tunnel, filled with blown active species, into which said fiber travels or (ii) a chamber provided with at least two electrodes respectively connected to a variable power supply, said electrodes being positioned opposite each other and defining between them a space suitable for the passage of a fiber portion, the whole zone being subjected to a controlled atmosphere at atmospheric pressure.

Other features and advantages of the invention will appear during the following description, illustrated with the following figures. Given below is:

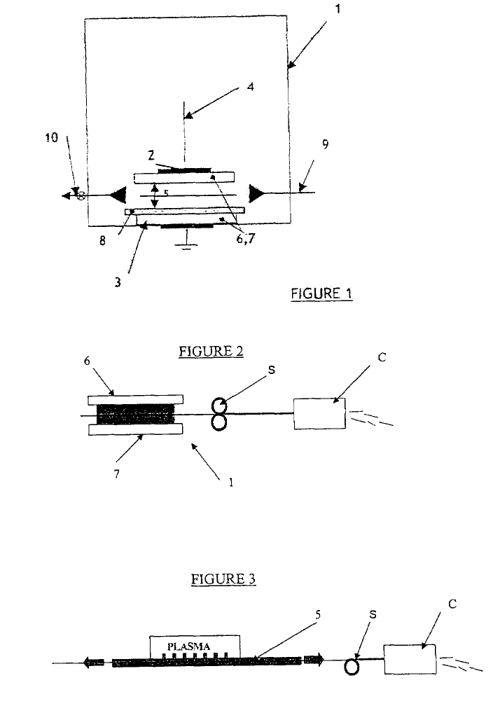

FIG. 1 is a schematic view of an installation for the implementation of the surface treatment method intended for treating a film;

FIG. 2 illustrates the integration of the installation from FIG. 1 allowing functionalization of a fibrillated fiber;

FIG. 3 illustrates the integration of a variant of the embodiment of the installation with transported plasma allowing functionalization of a fiber or a film, a fabric, a veil, or similar;

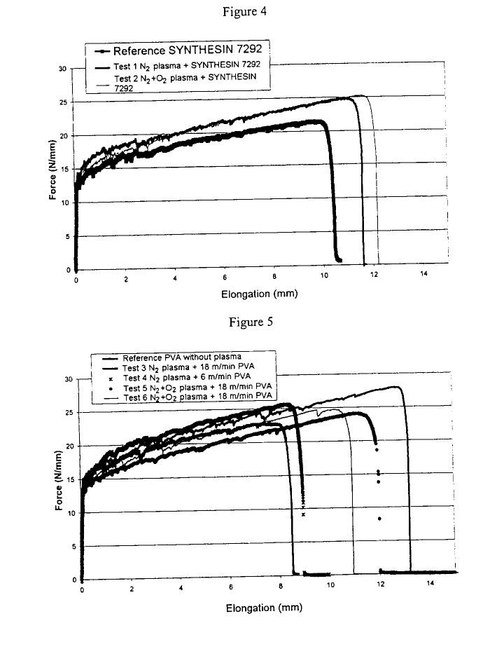

FIGS. 4 and 5 are tensile curves for various test pieces of cementitious matrix incorporating fibers functionalized according to methods of the invention;

FIG. 6 is an oscillogram of a filamentary state; and

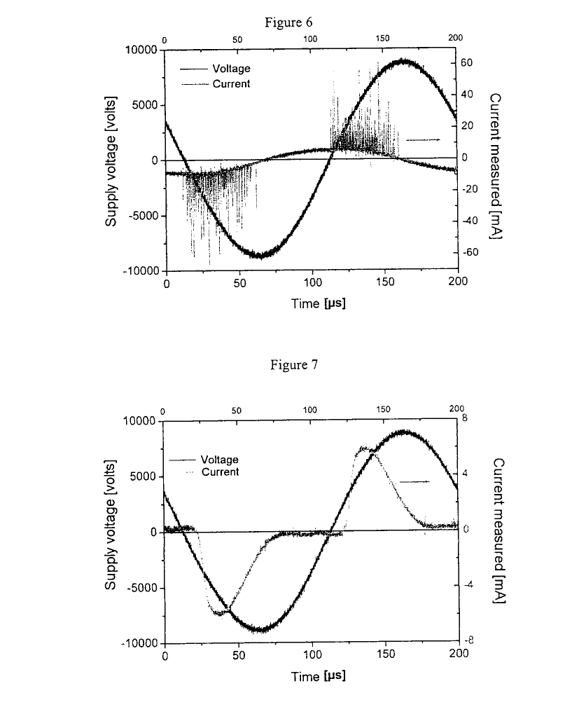

FIG. 7 is an oscillogram of a discharge in uniform state.

According to an embodiment of the invention, the latter consists in producing a “fiber-cement” product made from a hydraulic-setting composition comprising especially water, hydraulic binders and reinforcement fibers.

For reasons of simplicity, the present description refers to cement as binder. However, all other hydraulic-setting binders may be used in place of cement. Suitable hydraulic-setting binders are to be understood as being materials that comprise an inorganic cement and/or a inorganic binder or adhesive that hardens by hydration. Particularly suitable binders that harden by hydration are especially, for example, Portland cement, aluminous cement, iron Portland cement, pozzolanic cement, slag cement, plaster, calcium silicates formed by autoclave treatment and combinations of particular binders.

Within the meaning of the invention, fiber denotes an undrawn fiber (in the solid phase) and also a drawn fiber (drawn one or more times). And the fiber denotes a yarn, a filament and also a set of filaments (of textile yarn type) that are identical to or different from one another. The fiber may be continuous or chopped, short or long. It may also be a fiber said to be “fibrillated” that results from drawing a film along a chosen direction until tearing of said film into fibrillated fibers is obtained, which is initiated and controlled by a mechanical device.

According to an embodiment of the invention, a high-tenacity small-diameter (1 dtex=12 μm) unfilled fiber is used, obtained without mineral additives from polyproylene resin HF445FB from Borealis having a melt flow index (MFI) of 18 g/10 min measured at 230° C. and 2.16 kg.

On exiting the spinneret, which consists of a plurality of holes of diameter between 0.25 and 0.55 mm, preferentially about equal to 0.35 mm, the set of filaments solidify after a rapid cooling due to a cooling air flow that is controlled in terms of temperature, speed and direction.

The fiber is then drawn by mechanical means composed of rolls rotating at increasing speed, the rolls being temperature-controlled.

At least one surface portion of this fiber within the meaning of the invention (in the present case the fiber is drawn) is then functionalized, continuously, using an atmospheric plasma according to the methods that will be explained hereinafter.

After having been subjected to this continuous surface functionalization treatment, the fiber is then coated almost immediately after this plasma treatment, by spraying or by dipping, or via size rolls, with a size comprising at least one product based on polyethylene glycol fatty acid ester and phosphoric acid ester compounds based on natural oil such as the one with the trademark “SYNTHESIN 7292” from Dr. Boehme, or at least one product based on a lubricating and antistatic mixture such as the one with the trademark “KB144/2” from Cognis, or at least one product based on a fatty acid-derived polyethylene glycol ester such as the one with the trademark “STANTEX S6077” from Cognis, or at least one product based on nonionic surfactants and esterquats such as the one with the trademark “STANTEX S6087/4” from Cognis or an aqueous polyvinyl alcohol solution, at a proportion of 0.30% by weight of the polypropylene fiber solids.

By way of nonlimiting example, this chopped fiber functionalized in this way constitutes a reinforcement in a cementitious matrix.

The fiber is then chopped into 10 mm lengths in order to carry out the tests (incorporation in cement handsheets).

Within the meaning of the invention, a handsheet is defined as a product manufactured by a laboratory method reproducing quite faithfully the main characteristics of products obtained by industrial methods such as the Hatschek technique.

A cement composition is prepared based on the following cementitious matrix, suspended in a large excess of water:

| Components | Mass (in g) |
|---|---|
| CPA cement (95% clinker) | 79.2 |
| Calcium carbonate | 15.5 |
| Pinus Radiada refined cellulose | 3.5 |
| Polypropylene fibers | 1.8 |
| BASF AE70 flocculant | 400 ppm |
| TOTAL | 100 |

It is filtered through a metal screen to form an individual layer of about 1 mm thickness. Six individual layers are superposed and subjected to a pressing cycle in order to obtain a material comprising, before setting, about 50% water by weight relative to the weight of cement, and a thickness of about 6 mm.

This laboratory material is cured for 6 days at 40° C. in a sealed bag, before being cut into test pieces 20 mm in width and greater than 200 mm in length, which test pieces are placed in cold water for 24 hours before being mechanically stressed in tension.

For this purpose, it is necessary to use reinforcement fibers that may provide the product with the desired mechanical resistance properties, and that these mechanical resistance properties be sustainable over time. That implies that the reinforcement fibers initially introduced into the mix based on hydraulic binder and cement are not chemically attacked or are chemically resistant to the alkalis present in the mix, while improving the adhesion between the fiber and its matrix.

In this context, an embodiment of the method that is the subject matter of the invention consists simply of a continuous surface treatment of a surface portion of an organic film, veil, mat, woven or the like (hereinafter called the substrate) that meets these three objectives.

A surface portion of the organic-based reinforcement substrate is directed within a treatment zone, configured, for example, as an installation suitable for implementing the method. This installation comprises, schematically as shown in FIG. 1, first of all a chamber.

This chamber, represented by the reference 1 in this FIG. 1 has at least two electrodes 2 and 3, respectively connected to the terminals of a variable-frequency voltage generator 4. The electrodes positioned opposite each other define between them a treatment volume 5 suitable for the passage of at least one substrate surface portion 8.

According to another feature of the installation, each of the electrodes is coated with a dielectric layer 6, 7 facing toward the treatment zone 5. In the example of the embodiment represented in FIG. 1, each dielectric layer 6, 7 is based on alumina and is separated by a distance of between 0.1 to 20 mm, preferentially between 1 and 6 mm.

The chamber 1 is sealed from the outside environment and may contain an atmosphere that is controlled in terms of composition and pressure. For this purpose it has a plurality of lines 9, 10 intended for injecting and evacuating said atmosphere.

In the present nonlimiting example, the controlled gas atmosphere is at atmospheric pressure and is predominantly made up of nitrogen, helium or argon, used on its own or as a mixture with other oxidizing (O₂, CO₂, H₂O, etc.) or reducing (NH₃, H₂, etc.) species.

Due to this controlled atmosphere, it is possible to establish conditions conducive to the creation of a uniform discharge. By applying a suitable voltage to the terminals of the electrodes 2,3, in the case of this example, an AC voltage of around a few kV and at a frequency varying from kHz to a few tens of MHz, in the presence of said controlled atmosphere, a uniform electrical discharge is initiated.

It is recalled that within the meaning of the invention, and more generally, a discharge is said to be uniform as opposed to a corona discharge when it is impossible, at the macroscopic and microscopic scale, to perceive, between the electrodes, the presence of arcs or filaments or microdischarges between two electrodes subjected to a potential difference in a controlled atmosphere of a gas mixture as defined previously, and at atmospheric pressure. The type of state may be demonstrated by a voltage/current oscillogram (cf. FIG. 7). The presence of a uniform discharge confined between the electrodes 6, 7, in the treatment zone 5, makes it possible to functionalize, chemically modify or chemically activate a surface portion.

According to one embodiment example (cf. FIG. 2), the continuous surface treatment method that is the subject matter of the invention is used to modify at least one surface portion of the organic substrate, made up of olefin monomers, and more particularly based on polypropylene (PP). FIG. 2 illustrates an industrial embodiment of FIG. 1. Control of the plasma gas atmosphere is then achieved, for example, by gas barriers.

According to another preferred embodiment allowing implementation of the method that is the subject matter of the invention (represented in FIG. 3), a transferred or blown, filamentary or uniform, electrical discharge (also known as a plasma) is used, this is injected into a tube 5 within which the fiber (or a film, veil, nonwoven, fabric or drawn fiber, or more generally an organic substrate) travels and undergoes the functionalization treatment of its surface before being coated by dipping or by spraying, or by any other equivalent system, with a post-sizing agent (for example on a PP fiber by a composition based on PVA or SYNTHESIN 7292). After this post-sizing step, in an embodiment example having as its subject matter a PP fiber, the fiber is cut up. This post-sizing is illustrated by the reference S in FIGS. 2 and 3 using at least one size roll, a “spray coater” (slotted support, especially in ceramic, through which the size is injected) or similar, which makes it possible to deposit the sizing composition.

By way of example, the PP fibers will be described in further detail. These fibers generally result from the drawing of a polypropylene-based yarn or tape. The PP has no need to be modified by organic or mineral additives for the purpose of making it compatible with the hydraulic-setting matrix, this function being provided by the size. However, for particular applications, it may be envisaged to incorporate modifying additives or fillers, especially hydrophilic additives, into the matrix. Moreover, all the additives or fillers commonly used for fiberizing the polyolefin, in particular those intended to facilitate spinning, may be contained therein.

A reinforcement effect has been observed with PP fibers of relatively small cross section, expressed by a linear density of around 0.5 to 10 dtex, more advantageously of 0.5 to 2 dtex.

The cross section of the fibers is not necessarily circular and may take an irregular, especially multilobar, shape.

In this example, the PP fiber has a high tenacity of at least 4 cN/dtex, preferably at least 5 cN/dtex, very preferentially at least 7 cN/dtex, and in particular 8 to 10 cN/dtex. This tenacity range may be achieved by suitably adjusting the PP fiber spinning and drawing process. A PP fiber-based material with a suitable molecular weight distribution may be specifically chosen.

The fibers are generally in the form of yarns chopped to a length of around 2 to 50 mm, in particular 6 to 20 mm, using a cutter referenced C in FIGS. 2 and 3.

The overall quantity of sizing agent(s) present on the fiber is generally around 0.05 to 5% by weight of dry matter relative to the weight of polyolefin, especially around 0.1 to 2% by weight.

The drawing operation makes it possible not only to bring the transverse cross section of the fiber down to the desired size but also, considering the forces imposed during drawing of the fiber, to induce in the latter tensile stresses resulting in a reorganization of the macromolecular chains which are found to be better oriented.

The fibers according to the invention may also be obtained by fibrillation of an extruded polymer film (for example, based on polypropylene). The fibers may then be in the form of a tape.

The reinforcement fibers may be obtained from several commonly used grades of polypropylene.

The polypropylene fibers or some of the polypropylene fibers may optionally comprise fillers.

The surface portions of these fibers, whose surface has been chemically activated by the functionalization treatment that is the subject matter of the invention, are then brought into contact with a solution comprising at least one post-sizing agent making it possible to improve the chemical resistance, or the adhesion, of said surface portion to the cement, according to a first embodiment example. This contacting operation may be carried out in a conventional manner by a dipping, spraying or wiping-on process, a size roll, a spray coater or any other equivalent process.

According to a first embodiment, the agent in solution that is suitable for providing adhesion between the fiber and the matrix is a dilute 0.5 to 10%, more preferentially close to 2%, aqueous solution of PVA.

According to a second embodiment, the agent in solution is an industrial-type sizing composition. Given hereinafter is an industrial-type size comprising a mixture of products of the SYNTHESIN 7292 brand, between 0.5 and 10%, and preferentially close to 3.5%.

To demonstrate the benefit of the method that is the subject matter of the invention, comparative examples are given below illustrating the mechanical strength of the handsheets (a handsheet is a test piece having a cementitious matrix incorporating polymer fibers that are plasma-functionalized and coated with a post-size (either PVA or SYTHESIN 7292)).

The tensile tests were carried out by fitting the handsheets between the jaws of a tensile testing machine, with a distance between the jaws of 200 mm. The tensile test was carried out at a pull rate of 1.2 mm/min.

The force (F)-displacement curve is plotted, which has a shape typical of the tensile results observed with products obtained by the Hatschek technique (refer to FIGS. 4 and 5).

At the start of the displacement, the force increases rapidly, then a plateau is observed where the force develops slowly, corresponding to the multicracking of the test piece, until a macrocrack appears, after which the force drops by the slip effect during opening of the macrocrack.

The length of the multicracking plateau (L) reflects the sheet reinforcement effect by all the fibers. The energy dissipated (E) throughout the tensile test corresponds to the area under the force-displacement curve.

1. References without Plasma Surface Treatment:

| Reinforcement | Force | | L | | E | |
|---|---|---|---|---|---|---|
| type | (N/mm) | | (mm) | | (J) | |
| Reference | 21.5 ± 1.5 | — | 10 ± 2 | — | 4.1 ± 0.6 | — |
| SYNTHESIN | | | | | | |
| 7292 | | | | | | |
| Reference PVA | 20.2 ± 0.3 | −6% | 8 ± 2 | −20% | 3.3 ± 1.0 | −20% |

Given below are the mechanical properties of the reference fiber:

Diameter: 12 μm=1 dtex;

Tenacity: 9.5 cN/dtex or 860 MPa;

Modulus at 5% deformation: 6 GPa.

### 2. Influence of the Treatment Using a Blown Electrical Discharge (Plasma) on SYNTHESIN 7292:

The surface treatments were carried out using a commercial source from AcXys Technologies. The operating conditions used are given in the table below:

| | N₂ flow rate | O₂ flow rate | Power |
|---|---|---|---|
| Plasma | (slpm) | (sccm) | (W) |
| N₂ | 200 | 0 | 2000 |
| N₂/O₂ | 200 | 558 | 2000 |

The results of the mechanical tensile test are given in the table below:

| Reinforcement | Force | | L | | E | |
|---|---|---|---|---|---|---|
| type | (N/mm) | | (mm) | | (J) | |
| Reference | 21.5 ± 1.5 | — | 10 ± 2 | — | 4.1 ± 0.6 | — |
| SYNTHESIN | | | | | | |
| 7292 | | | | | | |
| Test 1 | 24.6 | +14% | 12 | +20% | 4.8 | +17% |
| N₂ plasma with | | | | | | |
| DR_{fiber} = 18 m/min | | | | | | |
| Test 2 | 25.1 | +17% | 12 | +20% | 5.1 | +23% |
| N₂/O₂ plasma with | | | | | | |
| DR_{fiber} = 6 m/min | | | | | | |

On concluding these tests on a PP fiber, with SYNTHESIN 7292, with a nitrogen-based plasma and for a fiber draw rate of 18 m/min, there was a considerable gain, of around 20% for example, in the energy dissipated in particular. This tendency is confirmed with an oxidizing plasma.

### 3. Influence of the Treatment Using a Blown Electrical Discharge (Plasma) on PVA:

The surface treatments were carried out using a commercial source from AcXys Technologies. The operating conditions used are given in the table below:

| | N₂ flow rate | O₂ flow rate | Power |
|---|---|---|---|
| Plasma | (slpm) | (sccm) | (W) |
| N₂ | 200 | 0 | 2000 |
| N₂/O₂ | 200 | 558 | 2000 |

The results of the mechanical tensile test are given in the table below:

| Reinforcement | Force | | L | | E | |
|---|---|---|---|---|---|---|
| type | (N/mm) | | (mm) | | (J) | |
| Reference PVA | 20.2 ± 0.3 | — | 8 ± 2 | — | 3.3 ± 1.0 | — |
| Test 3 | 27.7 ± 0.4 | +37% | 12 ± 4 | +50% | 5.2 ± 1.6 | +58% |
| N₂ plasma with | | | | | | |
| DR_{fiber} = 18 m/min | | | | | | |
| Test 4 | 25.6 ± 3.4 | +27% | 9 ± 2 | +13% | 4.5 ± 1.3 | +36% |
| N₂ plasma with | | | | | | |
| DR_{fiber} = 6 m/min | | | | | | |
| Test 5 | 24.1 ± 1.6 | +19% | 12 ± 5 | +50% | 4.8 ± 2.0 | +45% |
| N₂/O₂ plasma with | | | | | | |
| DR_{fiber} = 6 m/min | | | | | | |
| Test 6 | 24.9 ± 3.4 | +23% | 11 ± 3 | +38% | 4.6 ± 1.5 | +39% |
| N₂/O₂ plasma with | | | | | | |
| DR_{fiber} = 18 m/min | | | | | | |

On concluding these tests on PVA, a gain was observed of more than 40% in the energy dissipated, due to functionalization of the fibers using a N₂/O₂ plasma.

To illustrate these average values, some tensile curves have been chosen of which the force (F) and elongation (L) at break values of the composite during the test were close to the average value obtained above. These curves are given in FIGS. 4 and 5.

It was verified that the mechanical properties of the fibers had not been impaired.

Other examples are given below that make it possible to quantify the improvement in the adhesion between a functionalized fiber in a cementitious matrix. The adhesion of this fiber to a cementitious matrix was assessed by a laboratory test in which a fiber was coated with a mortar while leaving the ends of the fiber free, the mortar was subjected to a curing operation, then the ends of the fiber were pulled while measuring the tensile force and the displacement of the pulling points. The maximum force before fiber pull-out allows the adhesion strength to be determined, which is characteristic of the adhesion between the fibers and the matrix.

The preparation details were the following:

A mortar containing 500 g of CPA 52.5 cement, 500 g of fine sand (D₅₀=254 μm according to ASTM E. 11/70), 98 g of calcium carbonate and 250 g of water was prepared.

A taut fiber was placed in a parallelepipedal mold, with the fiber well-centered, and the mortar was cast around the fiber, without breaking the fiber. The mold was placed in a sealed bag.

Curing was carried out for 48 h at 20° C. and 95% relative humidity in a maturing chamber for setting the mortar. The contents of the molds were demolded and they were placed, with a small amount of water, in a heat-sealed bag kept at 40° C. for 5 days. The measurements were carried out on the 7th day after fabrication of the test pieces.

| Type | Adhesion strength |
|---|---|
| Reference with SYNTHESIN 7292 | — |
| without plasma treatment | |
| N₂ plasma + SYNTHESIN 7292 (Test 1) | +7% |
| N₂ plasma + PVA (Test 4) | +11% |

In conclusion, the plasma treatments make it possible to significantly improve the adhesion of the functionalized fiber within the cementitious matrix.

Moreover, if a TEOS-type silane precursor, which decomposes to form a layer of silica on the surface of functionalized fibers, is incorporated into the N₂/O₂ plasma, the measurements of the adhesion of the fiber within the cementitious matrix are even further improved (here, by a factor of 3).

| Type | Adhesion strength |
|---|---|
| N₂/O₂ plasma + TEOS (Test 7) | +30% |

The invention described above offers multiple advantages when the fiber is thus functionalized by an atmospheric plasma treatment and followed by post-sizing and a cutting operation, it may be used as reinforcement in a cementitious matrix. Such advantages of the invention may be obtained when the fiber is used as:
fibers for the reinforcement of paper:
   advantage: to provide paper with dimensional stability and mechanical strength (tensile and tear strength, etc.) due to the high tenacity of the fibers. The plasma makes it possible to modify the surface to make the fibers hydrophilic and to make them compatible with the papermaking process;
fibers for selective filtration:
   advantage: to benefit from a reinforcement plasma-functionalized by radicals making it possible to trap conveyed species by the filter medium of high tenacity for dimensional stability;
fibers for geotextile meshes:
   advantage: again the advantage of high tenacity, and the plasma makes it possible to functionalize the surface to make the fibers compatible with the coating that is essential for handling the meshes on construction sites;
fibers for reinforcement of elastomeric matrix composites.

According to an advantageous feature of the invention, the fibers thus treated have tensile mechanical properties that are improved by at least 10%.

1: A method for the continuous surface functionalization of an organic fiber, characterized in that a surface portion of said fiber is chemically modified using a uniform surface treatment at atmospheric pressure, in a controlled gas environment, and in that said surface portion is brought into contact with a solution comprising at least one sizing agent making it possible to improve the functionalities of said fiber.

2: The surface functionalization method as claimed in claim 1, characterized in that the functionalization of the surface portion of said fiber is carried out on a fiber deriving from the drawing of streams of molten material and from a drawing operation at a temperature below the melting point.

3: The surface functionalization method as claimed in claim 1, characterized in that the functionalization of the surface portion of said fiber is carried out on a surface portion of a fiber resulting from the fibrillation of a drawn film.

4: The surface functionalization method as claimed in claim 1, characterized in that the functionalization of the surface portion is carried out on a film drawn along a chosen direction until tearing of the film into fibrillated fibers occurs.

5: The surface functionalization method as claimed in claim 1, characterized in that the functionalization of the surface portion is carried out on a fiber selected from a woven, a veil, a nonwoven, and a mesh fiber or the like.

6: The surface functionalization method as claimed in claim 1, characterized in that the fiber portion is brought into contact with the sizing agent by means of an operation in which said fiber portion is dipped into a solution comprising said sizing agent.

7: The surface functionalization method as claimed in claim 1, characterized in that the fiber portion is brought into contact with the sizing agent by spraying a solution comprising said sizing agent onto said fiber portion.

8: The surface functionalization method as claimed in claim 1, characterized in that the fiber portion is brought into contact with the sizing agent by means of a transfer operation using a transfer device comprising a size roll soaking in a solution comprising said sizing agent, or a stationary guide conveying said sizing agent onto a line of contact with the fibers.

9: The surface functionalization method as claimed in claim 1, characterized in that said fiber portion is cut into a plurality of lengths.

10: The surface functionalization method as claimed in claim 1, characterized in that the surface treatment is carried out in a controlled atmosphere comprising at least one ionized gas chosen from helium, argon and nitrogen.

11: The surface functionalization method as claimed in claim 1, characterized in that the surface treatment comprises an electrical discharge which is produced between two electrodes subjected to an AC supply having a frequency of a few kHz to a few MHz.

12: The surface functionalization method as claimed in claim 1, characterized in that the surface treatment is carried out by blowing the active species from the filamentary or uniform electrical discharge toward the fiber, the transport of the active species taking place in a tunnel through which at least said fiber travels.

13: A fiber of which at least one surface portion is functionalized by the method as claimed in claim 1, characterized in that said fiber comprises polymer chains.

14: The fiber as claimed in claim 13, characterized in that the fiber consists of polymers, chosen from polyolefins, polyamides, polyesters, polyacrylonitrile and polyvinyl alcohols and copolymers thereof.

15: The fiber as claimed in claim 13, characterized in that the fiber is based on polypropylene.

16: The fiber as claimed in claim 13, characterized in that the fiber is coated with a sizing agent comprising polyvinyl alcohol in aqueous solution.

17: The fiber as claimed in claim 13, characterized in that the fiber is coated with a sizing agent comprising, in aqueous solution, a size comprising at least one product based on polyethylene glycol fatty acid ester and phosphoric acid ester compounds based on natural oil, or at least one product based on a lubricating and antistatic mixture, or at least one product based on a fatty acid-derived polyethylene glycol ester, or at least one product based on nonionic surfactants and esterquats.

18: The fiber as claimed in claim 13, characterized in that it is coated with a silica derived from the decomposition, of a silane-based precursor using an N₂/O₂ plasma.

19: The fiber as claimed in claim 13, characterized in that the tensile mechanical performance of the unfunctionalized fiber is improved by at least 10%.

20: An installation making it possible to implement the surface functionalization method as claimed in claim 1, characterized in that it comprises at least one treatment zone, said zone being either (i) a tunnel, filled with blown active species, through which said fiber travels or (ii) a chamber provided with at least two electrodes respectively connected to a variable power supply, said electrodes being positioned opposite each other and defining between them a space suitable for the passage of a fiber portion, wherein the whole treatment zone is subjected to a controlled atmosphere at atmospheric pressure.
